(19) United States
(12) Patent Application Publication
(10) Pub. No.: US 2007/0230486 A1
(43) Pub. Date: Oct. 4, 2007

(54) COMMUNICATION AND COMPLIANCE MONITORING SYSTEM

(76) Inventor: Emile Zafirov, Erie, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/692,686

(22) Filed: Mar. 28, 2007

Related U.S. Application Data
(60) Provisional application No. 60/743,901, filed on Mar. 29, 2006.
(60) Provisional application No. 60/908,352, filed on Mar. 27, 2007.

(51) Int. Cl. H04L 12/56; H04L 12/54

(52) U.S. Cl. 370/401; 370/428

(57) ABSTRACT

A system monitors packet data communications passing a network hub or port mirror, for example running on a network server or an appliance or as a set of distributed processes. A processor effects a programmed network probe method as a passive listener or sniffer. Packet data is selectively processed based on message protocol, content, addressing and similar criteria. Selected packets are re-assembled without packet formatting. Data servers temporarily store the content of selected data messages in a buffer for reference, and can index and permanently store data messages in an archive . A console and communication processes enable selection criteria to be set and revised, can be used to access stored messages, and provides alarms, logs and reports. The system enables monitoring of communications for compliance with policies, security watching and the like, without disrupting regular operations on the network.

### CROSS REFERENCE TO RELATED APPLICATIONS

This application claims the priority of U.S. Provisional Patent Applications Ser. No. 60/743,901, filed Mar. 29, 2006; and Ser. No. 60/908,352, filed Mar. 27, 2007. The disclosures of said applications are hereby incorporated herein in their entireties.

### BACKGROUND OF THE INVENTION

1. Field of the Invention

The invention concerns the field of supervisory monitoring of communications over a data processing network. In particular, a communication and compliance monitoring system is provided for versatile monitoring and reporting of communications activities and content, over a variety of data communication protocols. In one embodiment, the system operates from a server appliance coupled to a network, configured under control of a supervisory user. The server reads ongoing packet data communications, processes the data in certain ways, and controllably reports or logs activities and can store archive copies selectively. The server's functions are those of a passive observer that can selectively raise alarms and store records, as opposed to a gateway. Thus there is minimal interference with network activities.

2. Prior Art

It is generally known for supervisors of network systems serving a number of users to monitor the activities of the users, and to block and/or report upon certain activities that are considered undesirable for one reason or another. The reasons for such monitoring can vary depending on the character of the network, the relationship of the network operator to the users, and other factors. Monitoring might be conducted on an enterprise scale or only on a local area network or only for particular user terminals or user login identities.

Without limitation, monitoring might be desirable, for example, if an employer is interested in discouraging or preventing employees from engaging in nonproductive activity. Thus the employer might block web surfing or block access to consumer shopping websites or prevent access to risque subject matter. The employer might block streaming audio or video websites, or block news feeds so as to conserve bandwidth. These operations often involve intercepting communications to and from a web browser, but also could involve other types of programs such as file transfer protocol servers, email daemons and other programs.

In an operation where confidential or sensitive information is handled, such as a high technology company, a government or military group or the like, a security interest might be implicated. The network operator might be choose to prevent or to screen messages in such a network based on content or based on the IP address of the correspondents.

In other operations, there may be a tendency of users to push the bounds of legality. For example, certain users may participate in peer-to-peer file sharing systems that can be used for proper sharing of data files but often are used to disseminate proprietary data such as copyrighted programs or audio visual data. Users at a workplace may access pornographic sites that could subject an employer to objections on grounds of sexual harassment. It may be important for a network operator take steps in good faith to prevent such activities, at least to reduce the operator's risk of liability.

A data processing network can consist of users and servers coupled to an isolated local area or wide area network. Most networks are now coupled to the public Internet. The circumstances of communications over packet data networks in general and Internet coupled networks in particular, are such that the nature of the communication, the contents of the communication, the communication protocol, the identity or organization of the corresponding communicating users or networks, whether or not there is encryption or compression, and similar factors might all be considered in assessing whether there is a risk to the network owners or operators, a misuse of time or bandwidth by users of one class or another, or a reason for concern by the network operator.

On the other hand, a potentially risky communication might be wholly proper and within the expected range of duties of a correspondent. Thus when accessing a consumer shopping site, an employee could be acting on company business. When sending or receiving an encrypted communication, the employee may be acting in the best interests of the organization and its clients. It would be counterproductive for an employer routinely to block encrypted communications, access to some websites and similar user activities if the effect is to impede the flow of proper enterprise or user business.

It is also conceivable that different users of the same network may have different rights with respect to use of certain communication protocols. For example, it may be necessary for a public relations department to have access to news feeds, or to permit a Saturday mailroom shift to stream a sports event. What is needed is a versatile monitoring system that can be highly discriminating when necessary, that can permit an operator to customize the nature of monitoring, and that does not interfere with user business any more than necessary.

### SUMMARY OF THE INVENTION

It is an object on the invention to provide a versatile appliance for monitoring and management of communications activity on a packet data network, which appliance can serve such interests as data security, employee time management, compliance with policies and other uses. Particular communications can be selected for scrutiny according to a range of different criteria that may involve the sender or receiver category, addressing, message protocol type, presence of encryption or compression, and other aspects that can be discerned from the message.

It is another object to monitor communications without interfering with communications by operation of the monitoring system. Therefore, rather than intercepting and passing along message packets, the inventive system passively monitors communications activity among network users and between network users and outside entities, e.g., on the Internet. The system runs on a network server or appliance or as a set of distributed processes on two or more servers. At least one processor is programmed to effect a network probe function wherein the processor is a passive listener or sniffer. Packet data is processed based on message protocol, content, addressing and similar criteria, selective to assemble and record messages (or to ignore them). A data server is coupled to the processor or is provided as a related process in the same server, which can store the content of selected data messages for reference. A communication management process enables the criteria applied by the network probe function to be set and revised, and can be used to access stored messages, alarms, logs and reports. The system enables monitoring of communications for compliance with policies, security watching and the like, without producing a bottleneck or otherwise interfering with regular operations on the network.

In this way, based on identifiable message criteria selected using a supervisory or control process, the packet data messages may be ignored, or processed while stored temporarily, or stored permanently in an indexed archive, logged and/or made the subject of alarm messages or flags enabling supervisory review and action via a console function or otherwise.

These and other objects and aspects will be apparent from the following discussion of practical examples and operational embodiments.

### BRIEF DESCRIPTION OF THE DRAWINGS

There are shown in the drawings certain embodiments that are intended to represent non-limiting examples of the subject matter of the invention. The invention is capable of embodiment in other ways, consistent with this disclosure and with the scope of the invention as defined it the claims. In the drawings,

FIG. 1 is a schematic diagram showing the operational arrangement of the inventive communication and compliance monitoring system (sometimes abbreviated “CCMS” in this disclosure.

FIG. 2 is a block diagram showing certain core components of the invention and signaling and/or data connections coupling such components.

FIG. 3 is a more detailed block diagram detailing data flow and operational specifics of the network probe component.

FIG. 4 is a flow chart showing network probe loader and startup steps according to the invention.

FIG. 5 is a flow chart detailing network probe initialization.

FIG. 6 is a flow chart showing packet capturing initialization steps.

FIG. 7 is a block diagram showing components and interconnections of the system management console of the invention

FIG. 8 is an illustration of an inventive web based graphical user interface (GUI) that is also useful in explaining certain functions of the system and the manner by which the functions are accessed.

FIG. 9 is a block diagram showing components and processing blocks of the stored data server of the invention.

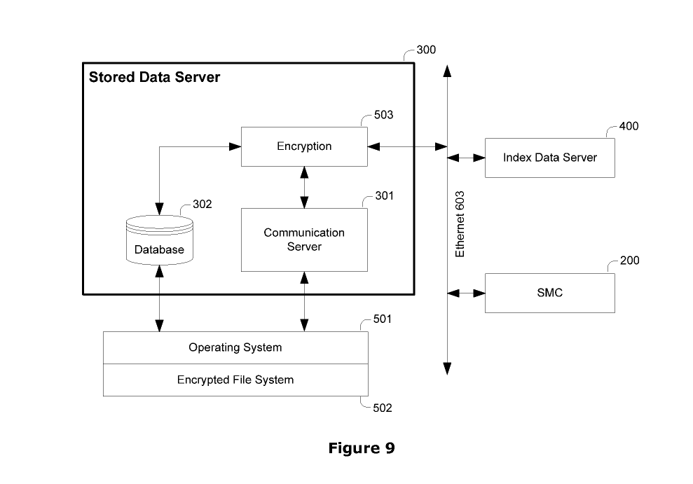

FIG. 10 is a block diagram showing the indexed data server of the inventive system.

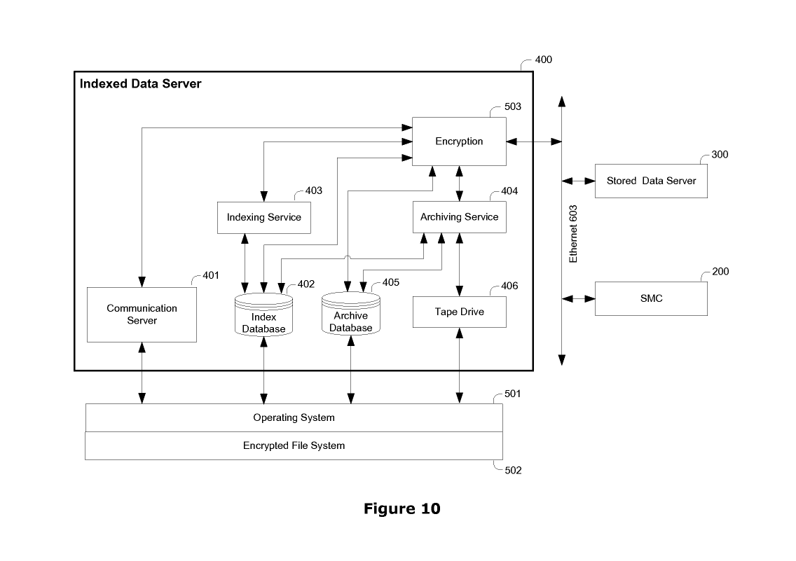

### DETAILED DESCRIPTION OF EXEMPLARY EMBODIMENTS

The subject invention is a communication and compliance monitoring system (abbreviated “CCMS”) comprising a platform designed for monitoring and analyzing network communications on a digital data network, such as an Internet Protocol (IP) data network wherein data is circulated in packets. The data may be involved in various sorts of network activities, including but not limited to browsing, email messaging and list manipulation, other forms of messaging, content streaming, file transfers, control signaling and the like.

The invention enables the packet data on the network to be monitored. In addition to monitoring or listening to packet data transfers as network operations proceed, the invention enables the data transfers to continue without disruption or interference during such monitoring. However, an operator can establish and modify criteria, using a console function, by which the packet data is treated selectively. The selective treatment can cause some data packets to be ignored, whereas others are copied and the copies re-assembled as copied of larger messages or file or the like. These can be further processed, for example for decryption, decompression or the other processing. Copies of selected content can be stored temporarily. Copies of selected content can be indexed and archived.

Communications are captured using passive network monitoring techniques (sometimes termed packet sniffing). Captured packets are stripped of the TCP/IP packet headers and are recompiled back into a continuous stream of data or contiguous file.

Among other criteria, the data can be processed based on the network protocol that carried the content and other aspects. Insofar as a copy of the data content is captured or regenerated, it can be stored in a database for further processing and viewing using data management aspects such as indexing by full text and by profile fields.

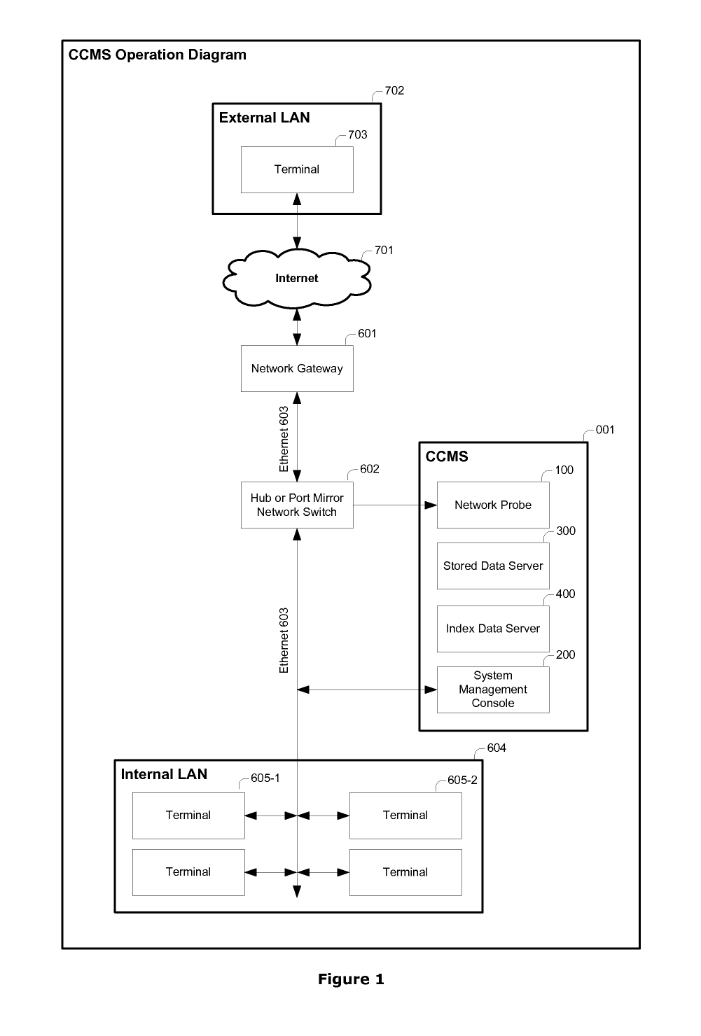

Referring to FIG. 1, a CCMS operational diagram shows a typical working environment for the system 001. The CCMS in this example operates on an Ethernet 603 communications channel and processes data messages exchanged by computer terminals 605 on a Local Area Network (LAN) 604 and remote terminals 703. In certain cases CCMS 001 can be arranged to process data messages exchanged between terminals on the same internal LAN 604. In that case, the messages need to move over the network apart from connections that are limited to couplings between terminals that are wholly isolated on the LAN. For example, the exchange may be mediated by a remote terminal 703 on an external LAN 702 where data messages sent by one of the local terminals 605 are arranged to leave the internal LAN 604 and reenter the LAN 604 to be received by another of the local terminals 605. Such a remote terminal can be, for example, an enterprise email server.

CCMS 001 is coupled to monitor (listen for or sniff) inbound and outbound network data packets traversing the network gateway 601. the CCMS in FIG. 1 is connected to a network hub or switch 602 with port-forwarding capabilities (also known as a mirroring function), that emulates the network data traffic with network gateway 601. That is, the physical network port used by the gateway is mirrored to the port used by the CCMS in a one-way communication feeding the network probe 100 to be discussed below.

In one embodiment, the CCMS is configured to recognize and process packets based on TCP/IP lower level protocol. It should be appreciated that it is also possible to enable other low level protocols such as UDP. In the case of TCP/IP, the following high level protocols are received for analysis and can be distinguished from one another by programming controlling the network probe element 100, which exploits differences in formatting, packet header flags and the like to determine whether a given packet is to be treated as one protocol or another:
Hyper Text Transfer Protocol (HTTP)
Simple Mail Transport Protocol (SMTP)
Post Office Protocol v.3 (POP3)
Internet Message Access Protocol (IMAP)
File Transfer Protocol (FTP)
AOL Instant Messenger (Oscar)
ICQ Instant Messenger (Oscar)
MSN Instant Messenger, and
Yahoo! Instant Messenger.

It is also possible that protocols can be carried by other protocols. Accordingly, the following tunneling protocols preferably also can be processed by the CCMS:
SOCKS version 4
SOCKS version 5, and
Hopster.

Preferably, the CCMS can detect multiple encrypted and other protocols as well. However, if parts of the content are encrypted, it is not possible to extend selective processing to vary as a function of those parts. However according to a preferred embodiment, certain encrypted and other protocols are distinguished by the CCMS by addressing criteria, in particular by their TCP port. The following protocols can be predefined in the CCMS by default, and this list can be extended as ports are user configurable:
Secure Shell (SSH)
Secure Socket Layer (SSL)
SMTPS
POP3S
IMAPS
FTPS, SFTP
Telnet over SSL
IRC over SSL
eMule
BitTorrent, and
Napster.

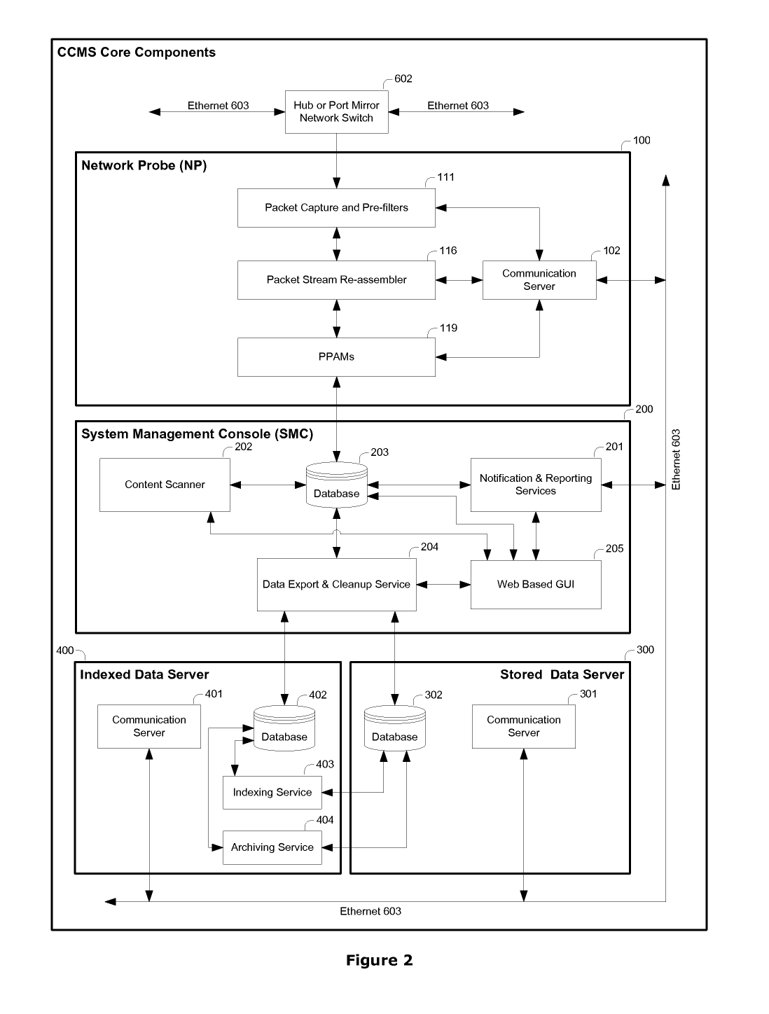

The CCMS preferably comprises a modular system of core components. FIG. 2 is a block diagram showing the CCMS core components and the links between them, the core components comprising:
Network Probe (NP) 100
System Management Console (SMC) 200
Stored Data Server 300, and,
Indexed Data Server 400.

FIG. 2 shows the core components in distinct boxes. Each of these components can reside on a different physical hardware server, or alternatively, the components can be logical subdivisions of one or more servers. In order to capture and process data, the network probe NP is required. The system management console is included to enable an operator to interface with the system through the web based GUI as well as to provide temporary data storage. The stored data and indexed data servers are optional but are useful additions.

The network probe 100 captures and analyzes network data packets. Packets are captured by a packet capture process 101 then are processed by a packet stream re-assembler 116. When assembled to define all or part of a message, the Protocol processing and analyzing modules (PPAM) 119 are invoked to discern whether the assembled message meets a selection criterion. The assembled messages, or at least a selected subset of the assembled messages, are stored in the SMC database 203.

Once saved in SMC database 203, the data is processed by a content scanner 202, including determining the presence or absence of predefined content strings. The results are saved back to Database 203. The information stored in the Database 203 can be accessed by the user using the web based GUI 205. It can be also processed by the notification and reporting services process 201. This section of the system enables quick response, for example using alarm signaling to alert a supervisor in the event of a message meeting a predetermined criterion, enabling supervisory intervention while the message and corresponding data are readily accessible in the database 203 of the SMC 200.

For purposes of long term data storage, data stored in database 203 can be exported by the data export and cleanup service 204 to the stored data server's database 302. Furthermore, the indexed data server 400 can index the data stored on stored data server 300 and store the results in its database 402 to facilitate searching and reports. Export from the SMC can be accomplished in a FIFO queue on a periodic basis.

The CCMS components are managed by the SMC 200 over the network 603, communicating with a communication server component of these core components as shown. The network probe, system management console and indexed data server are discussed individually in the following portions of this disclosure.

The network probe (NP) captures packets traversing the network gateway 601 and processes them at least insofar as needed in order either to detect certain network communications or to re-assemble the original data stream and further extract and save the data in that data stream. Said certain network communications can be predetermined to be ignored, examples being routine messages transmitted in a robotic fashion between network elements, which have highly predictable content without security implications.

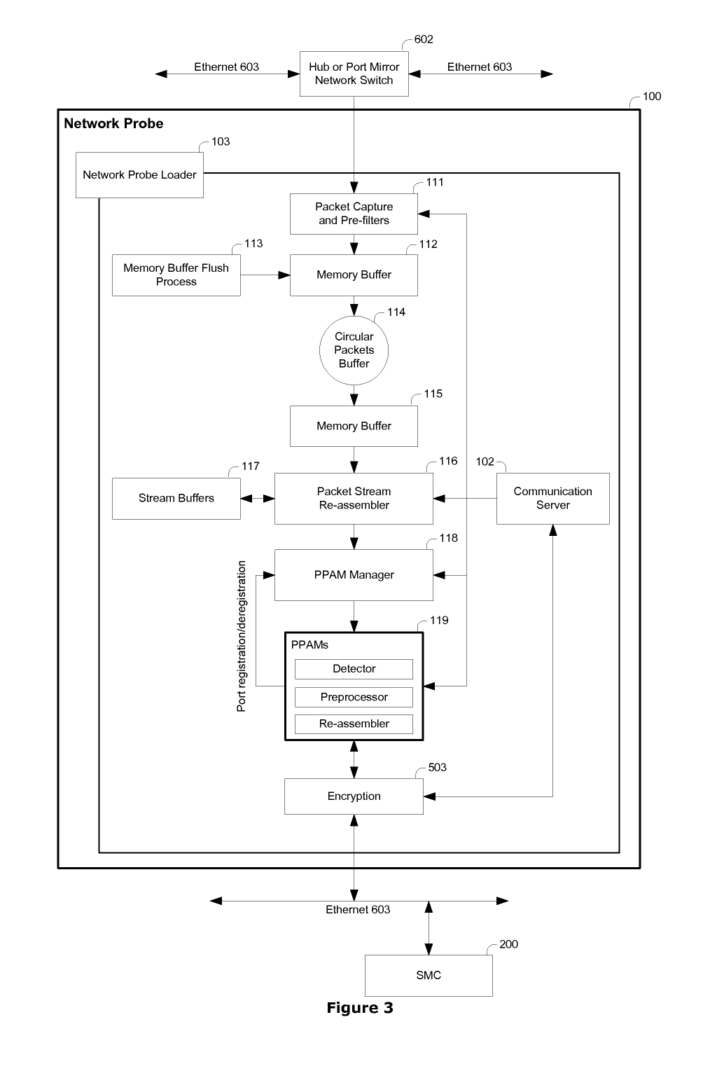

Referring to the network probe detail diagram at FIG. 3, the network probe 100 (“NP”) is initialized by a network probe loader process 103, and commences to monitor the mirrored port output of hub or switch 602, disposed in the path of packet data to be monitored. Once the NP is loaded, monitoring is commenced and proceeds continuously for network packets. As network packets are captured their source/destination IP addresses and ports are checked for correspondence with a list of pre-filter rules. If a packet matches a pre-filter rule, it can be instantly dropped (i.e., ignored). This early screening mechanism reduces the extent to which system processing and storage resources are devoted to unneeded packets.

Packets that pass the pre-filters are stored in memory buffer 112. From the memory buffer 112, packets are stored in a circular on-disk buffer 114 which is considerably larger than the memory buffer. The memory buffer is needed so the NPs can handle network bursts. When the memory buffer 112 is filled, the contents of the memory buffer are transferred to the on-disk buffer 114. However, in some situations network traffic may decrease or slow to the extent that the memory buffer 112 retains its contents for a relatively long period of time. In those cases packets stored in the memory buffer could wait a long time to be processed. A memory buffer flush process 113 is provided to prevent the data in memory buffer 112 from being hung up when it is not pushed along be new data. The flush process comprises an internal timing function. If a predetermined interval is exceeded (for example by passage of time or by a given number of processing cycles), the process will flush the memory buffer, thus causing the NP to transfer the memory buffer to the on-disk buffer. After flushing, the timer can be reset.

Packets stored in the on-disk buffer are loaded in second memory buffer 115 where they are processed by the packet stream re-assembler 116, which puts the packets back in order. The packet stream re-assembler matches up packets for different message paths by associating those with the same source/destination IP addresses and ports, and orders the packets by their TCP packet sequence numbers.

At this point, the packet subdivisions are no longer needed. The re-assembler strips the TCP/IP headers and concatenates the data to an existing stream of reassembled packets, or starts a new one. If the packet belongs to an existing stream of packets, the re-assembler checks if the stream is completed by the latest packet. If so, the re-assembler passes the completed stream to the PPAM manager 118.

If the packet is starting a new stream of packets, the source/destination IP addresses and ports are sent to the PPAM manager 118. The PPAM manager 118 may signal back to cancel re-assembling of the packets for that stream, for example in the situation that the stream cannot be processed by the system, for example because the stream contains encrypted communication for which there is no decryption code or algorithm, or because the communication type is not one of the protocols supported by the CCMS. Assuming that the stream of packets is supported and processes, once the last re-assembled packet is reassembled in sequence order, the message content is passed to the PPAM Manager 118 for further processing.

The CCMS Network Probe is designed around a flexible plug-in system where each plug-in handles one or more high level protocols. For example, respective plug-ins may handle HTTP, POP3, etc. In the CCMS terminology those plug-ins are called protocol processing and analyzing modules or PPAMs. According to an aspect of the CCMS, it is possible to add new modules to service new high level protocols that may arise.

At NP, startup the PPAM Manager 118 loads the PPAMs 119 available in the system or all those selected for loading by appropriate console commands. As each PPAM registers, it provides the manager with information identifying protocols that the PPAM is capable of processing. This can be done by specifying a network source and/or destination port.

The PPAMs can also request notification by the PPAM manager 118 at the beginning of every packet stream and/or for every packet in the stream. More than one PPAM can request to be notified for packets using the same port (protocol. Using this information, the PPAM Manager 118 knows which PPAM can be used to process given packet stream. The PPAM itself takes care to properly decode the information in the packet stream and once that is done the data is stored in the SMC's database 203 (this database 203 is also identified herein as the recent data database). Some of the protocols have dynamic nature meaning that more than one connection may be established between the server and the client using random network ports. To handle this, the PPAM Manager 118 provides the PPAMs with the ability to dynamically register/deregister network ports and/or IP addresses in which they are interested. In a practical embodiment, the NP has been executed using C++ code for its core engine, and Python code for some of its the peripheral tasks as well for some of the PPAMs.

To allow easy interoperability between the different C++ objects, the CCMS uses an object registry. The object registry is a list of pointer to objects with an assigned tag for each pointer. Whenever an object is created and initialized, it receives a pointer to the object registry. This way the object can query the registry for other objects using the object's tags.

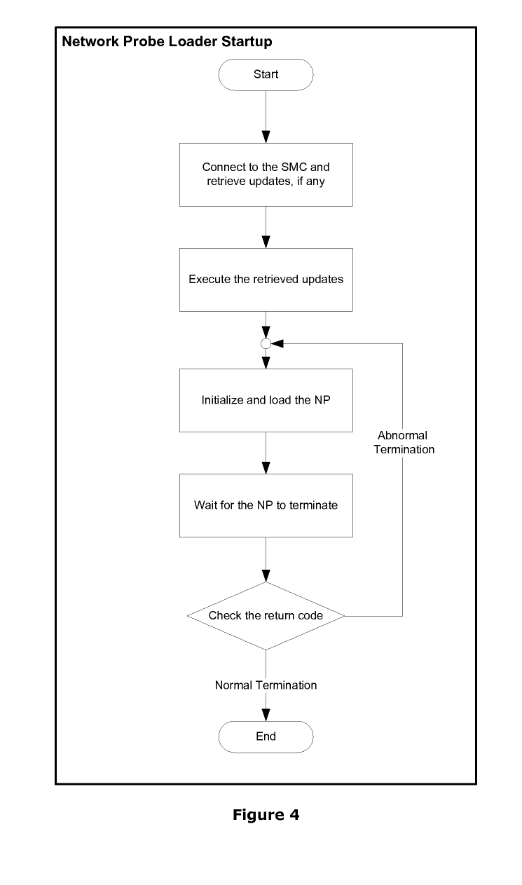

The network probe NP is started indirectly by the NP Loader 103 as can be seen from the Network Probe Loader Startup diagram on FIG. 4. The NP Loader first tries to connect to the SMC server 200. On successful connection it queries the SMC's database 203 for NP or system updates. If updates are available, the NP Loader downloads them to a directory and applies them before it loads and commences operation of the NP itself. Updates are distributed as Python scripts that may carry any binary information. Once the updates are installed, the NP Loader starts the NP itself as a new process after which it blocks on the new process, waiting for the process to terminate. When the NP process terminates the NP Loader check the process exit code and if the process terminated abnormally it restarts the NP process.

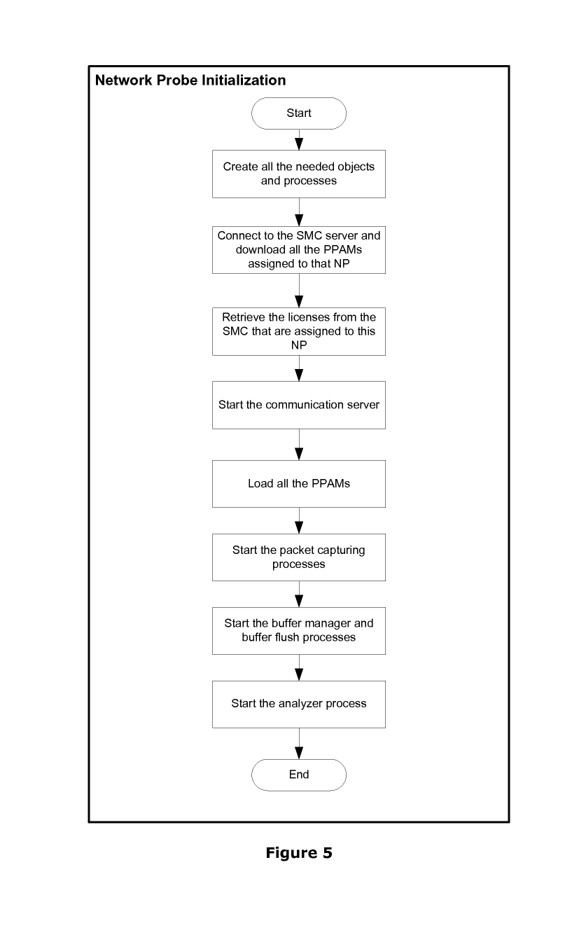

Once the network probe NP process is started by the NP Loader, the NP process commences a sequence of steps to initialize the components needed for the operation of the NP. The network probe initialization diagram in FIG. 5 shows the process and steps.

Initially, an instance of a log manager object is created. The log manager is used to record log entries into the SMC database 203. The NP loads several settings, e.g., from a local XML file. This settings file can contain information comprising network interface(s) that the NP should monitor for packets (at least one or more being for data communication capture); the network interface which the communication server should monitor for commands from the SMC (the system management interface may also be the same as the one used for capturing); and memory and on-disk buffer sizes.

Once the settings are loaded, the NP: creates a packet capture process 111 for each network interface specified in the settings file; allocates the memory buffers 112 and 115; creates buffer manager object; creates the memory buffer flush process 113; creates the PPAM manager 118 and the analyzer process in which the PPAM Manager runs; creates the packet stream re-assembler 116 object; and finally, creates the communication server process 102.

When the needed objects and processes have been created, the NP connects to the SMC 200 and downloads the PPAMs assigned to that NP. This way the NP uses the latest versions of the PPAMs, and updating the PPAMs is facilitated when necessary. Also the NP retrieves its assigned licenses from the SMC server and saves the information into a local XML file.

Next, the NP can commence operation of the processes that were created earlier. The communication server 102 process is started on the management network interface. The communication server opens a TCP socket on port 13 and blocks on the socket waiting for incoming data.

Next the NP calls the PPAM manager 118 object's function responsible for loading the PPAMs. The PPAM manager 118 scans the local directory and its subdirectories where the PPAM are located and loads each PPAM. PPAMs are compiled as shared object (SO) modules. Each PPAM is loaded into the memory and a “Create” method is called from the SO. The “Create” method returns a pointer to a PPAM object which is stored in a hash table using the PPAM name as key.

Once the PPAMs are loaded by the PPAM Manager, the network probe NP starts capturing packets in process 111. The packet capturing process monitors for packets on the network interface to which it was assigned.

The network probe NP initializes the buffer manager object. The buffer manager is responsible for synchronizing access to the memory buffers 112 and 115 and the on-disk buffer 114. All the processes that need to write or read from those buffers use the buffer manager to do so. In this way, read and write operations are coordinated and pointers cannot be incremented or data overwritten by independently operating processes.

After the buffer manager is started, the network probe NP starts the buffer flush process 113. This process waits for a certain length of time or amount of data and flushes the memory buffer to the on-disk buffer.

Finally, the network probe NP starts the analyzer process. The analyzer process carries out all of the tasks on getting data from the packet stream re-assembler 116 and passing that data to the PPAM manager 118. The created objects are added to the object registry.

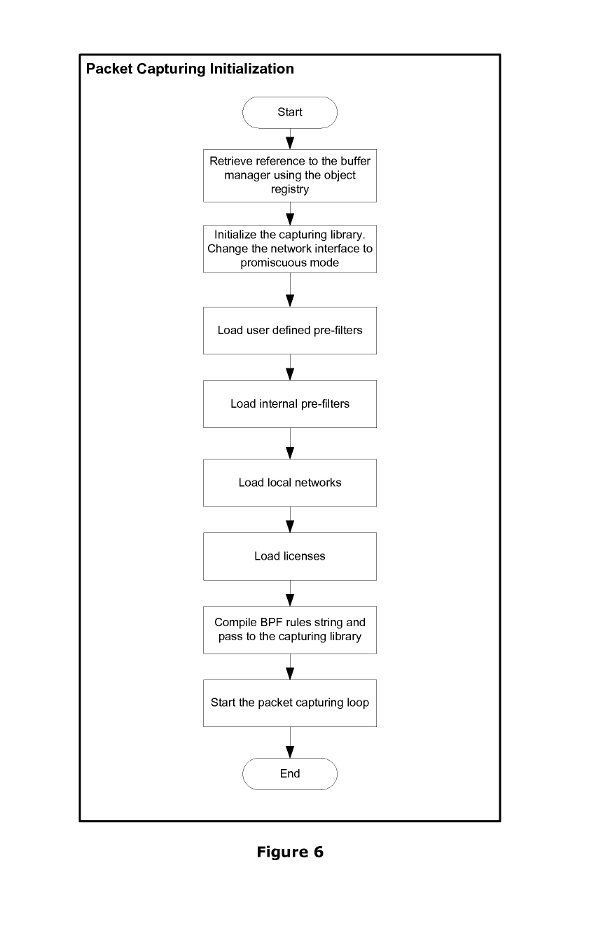

Referring to FIG. 6, concerning packet capturing initialization, when the packet capturing process 111 is started, it queries the object registry for a pointer to the buffer manager object and initializes the packet capturing library. The packet capturing library changes the assigned network interface to promiscuous mode, allowing the network interface to process all the network packets as opposed to processing only packets designated for its MAC address. Once the packet capturing library is successful initialized, the packet capturing process 111 loads user defined pre-filters.

Next, the process loads internal pre-filters which define types of network communications that should be ignored by the network probe NP. Examples include NetBIOS, SNMP, etc. As those protocols are not subject to monitoring by the CCMS, there is no need for them to be captured and processed. The internal pre-filters preferably are predefined defaults in the system that cannot be edited by users.

After the internal pre-filter, local networks are loaded. The local networks are pre-filters that allow packet capturing only if at least one of the source and the destination of the packets is in one of certain defined networks. They also define which networks are local to the NP allowing the NP to properly identify local and remote hosts. This aspect allows the network probe NP to monitor a particular LAN or group of LANS, which permits a CCMS to be configured with regard to the job functions of the users or other information that is specific to the LAN or LANS.

A larger network can be provided with multiple CCMS units for different LANS. As a further step, the packet capturing process loads licenses. The CCMS licenses are assigned per network probe NP, as a function of which IP addresses should be processed. This can be handled by using network addresses and corresponding network masks to select a subdivision of possible network addresses. For instance, if the user wants to capture data only for 4 IP address from 0 to 3 on the 192.168.0.0 network the license fill be defined as network 192.168.0.0 with subnet mask 255.255.255.252. Using networks and network masks allows for flexible definition of monitored groups within a computer network, without the need for redefining the network space in order to integrate a monitoring system.

Unlike user defined pre-filters, the licenses and the local networks have the opposite logical meaning—namely to accept packets only from the hosts defined by the rules.

All the pre-filters are loaded from local XML files. License information is retrieved from the SMC each time a NP starts and is stored to a local XML file. Entries in the XML files can describe single host as well as network and also (but not necessarily) a network port. If the pre-filter describes a host and the host name is provided as opposed to an IP address, the name will be resolved first and then the IP address will be used. If the name cannot be resolved the pre-filter entry is skipped. After the pre-filters and licenses are loaded, a Berkeley Packet Filter (BPF) rule string is created and passed to the packet capturing library which further uses it to decide which packets should be processed and which dropped.

After the packet capturing library is initialized, the packet capturing process 111 starts a loop. The loop is controlled by an internal Boolean variable which is used to terminate the loop whenever the process is destroyed. Inside the loop, the packet capturing library is queried by the packet capturing process for new packets. Each new packet that is returned by the library is added to the memory buffer, using reference to the buffer manager object retrieved via the object registry. After the packet is added to the memory buffer, the loop goes into the next iteration, again querying the packet library. The loop repeats until the value of the control Boolean variable changes to False, which terminates the loop and exits the packet capturing process.

The network probe NP components preferably do not have direct access to the buffers. Only the buffer manager can manipulate the buffers, thus providing synchronization between the different processes and organized memory access that prevents overwriting and other problems associated with near simultaneous access by different processes. Synchronization is ensured by using system locking objects such as mutexes. For better efficiency, separate locking objects are used for the memory and for the on-disk buffers.

When the packet capturing process 111 has captured a packet, the process passes that packet to the buffer manager. The manager locks the memory buffer 112, gets the current system time, and calculates the total memory size that will be needed to store the size info, the time stamp and the packet data. The manager checks to see if enough space is available in the memory buffer 112 to store the packet data. If the space is not enough, the contents of memory buffer 112 are transferred to the on-disk buffer 114 first, and the buffer pointer is reset to the beginning of the buffer. When there is enough space, the manager stores the size then the time stamp and finally the packet itself, changes the buffer pointer to point after the data that was just written and unlocks the memory buffer 112.

The memory buffer 112 is transferred to the on-disk buffer 114 either when it is full or when the buffer flush process 113 flushes it. The on-disk buffer 114 is organized as a file circular buffer, meaning that the buffer has predefined size and when the end of the file is reached, writing starts from the beginning of the file in circulating pointer manner. To keep track of the on-disk buffer size, the manager uses two pointers—one pointing to the beginning of the data in the buffer and the other one pointing at the end of the data.

When writing the memory buffer 112 to the on-disk buffer 114, the manager locks both buffers 112, 114 to prevent read/write operations by other processes. The whole memory buffer is transferred to the on disk buffer and the pointer pointing the end of the data is updated respectively. The manager performs several checks to make sure it won't override data in the on-disk buffer 114. Once the data is written, the locks for the two buffers are lifted. The current pointers for the on-disk buffer 114 are stored in two separate files.

Each time the memory buffer is transferred to the on-disk buffer 114, a timer associated with the buffer flush process is reset. As noted above, the buffer flush timer is intended to force a transfer to the on-disk buffer 114 if too much time elapses without the memory buffer 112 becoming full so that a transfer is needed for that purpose. Resetting the timer after each transfer prevents the process from flushing the buffer a second time unnecessarily, before the time since the last transfer reaches the timer limit.

Reading from the on-disk buffer is done in a similar way as writing. A second memory buffer 115 is used to store the data from the on-disk buffer 114. Again, the two buffers are first locked to prevent any other process from accessing them. Data is read from the on-disk buffer 114 to the memory buffer 115 after which the pointer pointing at the beginning of the data in the on-disk buffer 115 is moved forward to reflect the current buffer state. After the data is read the locks are removed.

The analyzer process reads packets from the buffer manager and passes those packets to the packet stream re-assembler 116. The re-assembler, in turn, calls back the analyzer process for each packet and for each re-assembled data stream. The analyzer process then uses the PPAM manager 118 or the information already stored within the stream itself to decide to which PPAM the packet/data stream should be passed for processing. The packet stream re-assembler 116 puts the network packets back together in data streams in sequential order because packets in TCP/IP may arrive out of order for various reasons. When the re-assembler receives a packet for processing it looks up the source/destination IP addresses and ports. The IP addresses and port information are used to generate a unique hash code which identifies a packet stream and enables searching through a list of concurrently accumulating network streams managed by the re-assembler. If a corresponding stream exists, the packet's data is added to that stream. If not, a new stream is created and entered in the list. The re-assembler also checks the TCP state flags from the TCP header to determine check whether a given packet was sent as the first or last one in the stream. If the stream is complete, the TCP connection between the sender and receiver is closed or is about to be closed. The re-assembler can complete processing of the stream when the packets are in hand, or deal with a missing packet and terminate processing of a stream.

Whenever the re-assembler adds a new packet to an existing packet stream it checks the packet sequence number to determine the right packet placement in the stream. The packet streams are dynamically stored in the memory by using hash tables and bidirectional lists. The hash code for the hash table is generated by using the source/destination IP addresses and ports. Using hash tables to store the streams speeds up packet-stream lookup process.

When a new stream is created, the re-assembler passes the information about the stream to the PPAM manager in order to determine which PPAM(s) should process that stream. The information about the PPAMs that will process the stream is then stored with the stream itself.

The protocol processing and analyzing modules (PPAM) are the modules that process the data streams produced by the network flow re-assembler. There are at least three types of PPAMs in the preferred configuration, namely detectors, preprocessors and re-assemblers.

Detector PPAMs are discern that a certain communication is based on a given source and/or destination port and/or certain data patterns found in the packets in the case of protocols that use dynamic network ports to communicate. Upon detection of such protocols, information is sent to the SMC server 200 and stored.

Preprocessor PPAMs are discern protocols such as Socks and Hopster, which can encapsulate other protocols instead of carrying data by themselves. The preprocessors can detect encapsulation protocols either by source/destination ports or by certain patterns found in the protocol's data. If an encapsulation protocol is recognized, the preprocessors “strip” the additional data created by the encapsulation protocol to produce data in the underlying protocol, which data is then passed on to one of the re-assembler PPAMs. No actual data needs to be stored persistently by the preprocessor PPAMs.

Re-assembler PPAMs are used to process captured data for high level protocols such as HTTP, SMTP, POP3, etc. The protocols are discerned by their source/destination network port and the appropriate PPAM is used to re-assemble the data message carried by the protocol. Once the data is re-assembled it is submitted to the SMC server 200 for storage.

In CCMS, PPAMs preferably are implemented as shared objects (SO). They inherit and implement one interface class, thus allowing the rest of the components of the system to access them in a similar manner. The PPAMs are extended with external Python modules. The Python modules take care of the actual data processing and data storage. Each PPAM loads it settings from a local XML file.

Structurally, PPAMs are divided into three parts, namely the shared object file and the Python scripts that are loaded by the PPAM manager 118; Python scripts that are copied to the web server to be used to display the PPAM data; and SQL scripts that are applied to the database to create database objects that a PPAM needs to store its data. There are two steps in installing new PPAMs in the system. First the PPAM to be installed is stored to the SMC server 200. Next the PPAM can be assigned to a network probe NP. When an NP starts, it downloads the PPAMs that were assigned to it and does the actual install. Initial configuration files are downloaded with the PPAMs as well, containing default values. However the user may change the configuration of each PPAM but the changes will be saved as a local XML file at the NP thus providing the NP with its specific PPAM settings.

The approach as described allows for granular control over the protocols and sub protocols or proprietary features implemented by different applications over standard protocols. It is readily possible to revise or update PPAMs and to provide new ones.

The PPAM manager 118 is responsible for loading the available for a particular network probe PPAMs. The PPAM manager 118 uses three different lists to store references to the loaded PPAMs. It uses one list for each PPAM type. The PPAM manager 118 also takes care for unloading PPAMs if they are uninstalled from the NP. The rest of the CCMS components can retrieve a reference to the PPAM lists and then query or pass data to the PPAMs from that list.

The network probe NP stores all of the processed data to the SMC server 200 to which it is connected. There is no intermediate data module in the NP. Instead, PPAMs store their data directly to the SMC's database 203. Whenever a PPAM is uploaded to a SMC, the SMC's database 203 is updated using SQL scripts that the PPAM carries. This way the database has the correct data structure to accommodate the data stored by the PPAM. This approach allows for the CCMS to be transparently updated and expanded with new PPAMs whenever a new communication protocol or application is introduced or becomes of particular interest to CCMS customers.

Preferably, a few common data tables are provided and are used by all the PPAMs. The two main data tables are Events Log and Conversations tables. The Events Log table contains events in a chronological order, where event means a communication that was either only detected or processed and re-assembled. The Conversations table is similar to the Events Log table with the exception that it only contains one entry for a given source/destination IP address and protocol and thus grouping the events into conversations (similar to the concept of message exchanges in the case of email or message threads in nntp news servers). There are additional tables that contain the information about the hosts found in the network. Whenever a PPAM discovers a new host that is not yet in the hosts table the PPAM adds that host.

The communication server 102 monitors for commands from the SMC server 200. When a network probe NP configuration is changed via the GUI 205 at the SMC server 200, the SMC server 200 sends a command over the network 603 to the corresponding NP's communication server 102, using the communication client 206. In one embodiment, the following commands are provided and can be issued to the communication server by the SMC server:
Connect NP to SMC.
   This command is issued when a NP is connected to a SMC server by the user. The command results in the re-initialization of the NP thus reloading all he PPAMs and pre-filters.
Add/remove PPAM.
   This command is issued whenever the user adds or removes a PPAM from a NP. The PPAM is either downloaded from the SMC server and initialized by the NP or removed from the NP, depending on the command.
Change PPAM settings.
   As PPAM settings are per NP, a command containing the new settings for a PPAM is send to the NP whenever the user changes the settings at the SMC's GUI 205. The PPAM is then reinitialized with the new settings.
Change pre-filters.
   This command is sent when the user changes the pre-filters of a NP. The command contains a list of the pre-filters that have to be applied to the NP. After that command is received the NP resets and reloads the pre-filters.
Change local networks definition.
   Changing the local network issues a command similar to the command that changes the pre-filters.
Change the licenses.
   Licenses are changed the same way as pre-filters.
Change NP properties.
   This command is issued when the NP's properties are changed by the user.
Request NP statistics.
   This command is sent whenever the SMC needs to show the NP's statistics—CPU, memory, buffer size, packets statistics. The NP responds with all the required data.
Disconnect the NP from the SMC.
   This command is used whenever the user removes a NP from a particular SMC server. The command removes all the PPAMs and re-initializes the NP.

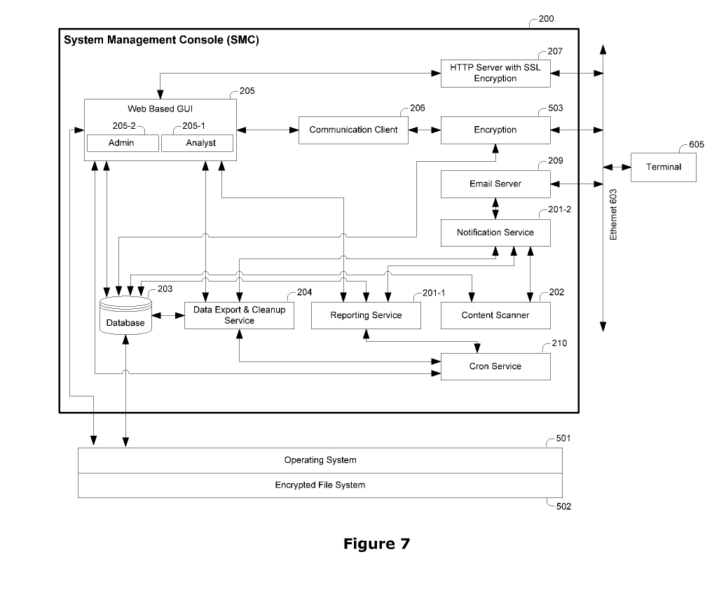

The System Management Console (SMC) 200 controls the SMC server components. As shown in FIG. 7, the SMC comprises several following components. A web server 207 (http) with SSL encryption, provides web based GUI 205 for the users. A database 203 stores the data captured by the NPs assigned to the particular SMC. A content scanner 202 scans the content in the database 203 for predefined keywords and Boolean expressions. A data export and cleanup service 204 exports data from the SMC's database 203 to the Stored Data Server 300. At least one reporting service 201-1 generates user defined reports. At least one notification service 201-2 is used by other SMC components to send email notifications/reports to users. A cron or timing service 210 scheduled data exports and reports. A communication client 206 communicates with other CCMS components

The web based GUI 205 allows users to control the CCMS and its components as well as to review data captured by the CCMS. The GUI is build using Python server pages served by the web server. The web server is configured to only allow SSL encrypted connections thus providing secure access to the GUI.

The GUI 205 is shown as divided into two sections—Admin 205-2 and Analyst 205-1. These represent two types of users that access the respective GUI sections depending on their user function. Admins are responsible for system configuration and maintenance. Analysts are users that can man the console during communication monitoring where appropriate, for example to receive alerts and reposts. This dual role approach provides for a system of checks and balances within the group that is responsible for monitoring communications. The GUI checks the user type upon login (e.g., by a username/password selection or perhaps by selection when an authorized use so indicates by selection of options offered. The GUI directs the user to the appropriate section.

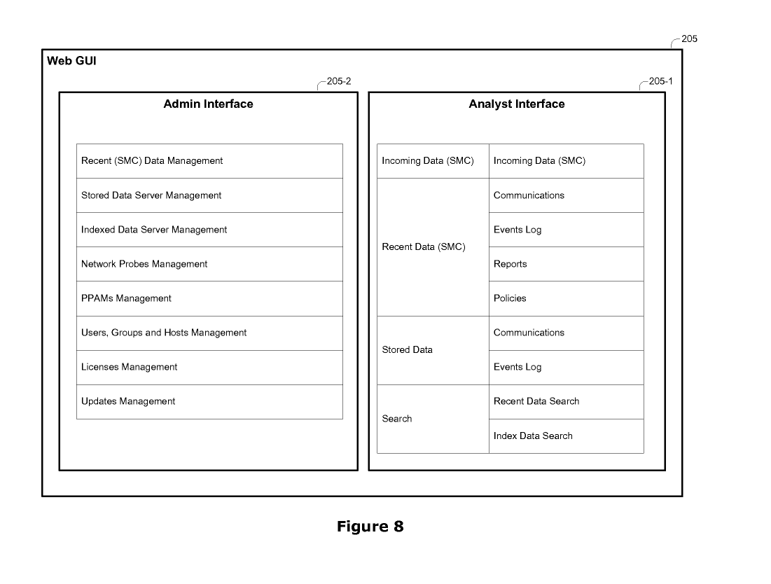

The Web GUI diagram on FIG. 8 shows the main functions of GUI 205 in one embodiment. A more detailed description of the GUI and CCMS operation is available in a CCMS user manual, which is contained in U.S. Provisional Patent Application Ser. No. 60/908,352, filed Mar. 27, 2007, which application is incorporated by reference in this disclosure as if fully set forth.

Data captured by network probes 100 is stored in the SMC's database 203. The database also stores system wide settings. The database 203 is secured using encrypted file system 502.

The content scanner 202 scans for keywords or combinations in the captured data according to predefined keywords grouped in policies, or by keywords submitted by the user through the search function in the web GUI 205-1. For policy searches, the content scanner runs as a background process. For user searches, the content scanner is called in the context of the web server. When the content scanner 202 is started as a background process, it tries to load the last database IDs searched. The IDs are stored in an external text file. If the IDs are not found, the default is zero. Once the last searched IDs are loaded, the content scanner loads the entries from the Events Log tables that haven't been searched yet along with the policies data. Next, the content scanner starts to iterate through the entries from the events log table comparing each entry to the policy criteria, i.e., protocols, hosts and groups of hosts. If an entry matches the filters defined by a policy, the content scanner retrieves the actual data for that event entry by using a stored procedure created during the installation of the corresponding PPAM. That procedure will return the data for a given event along with message/data encoding, local host ID, message type and the message binary data itself. After the content scanner retrieves the necessary information about the entry, the content scanner can convert the message data to text, removing unnecessary information. This is accomplished by using the message type and the data encoding. Different data types are converted to text differently by using either built in functions or by using external libraries.

Once the content scanner acquires the text representing the data message, the content scanner compiles a search expression based on policy keywords (policy rules). Next, the content scanner searches for the search expressions in the message text, for example using the grep algorithm. If there is a match, the content scanner marks the entry in the database 203, linking the message to the policy that the message matched. Depending on whether settings associated with the policy so require, an alert is generated by the notification service 201-2 to specified users, containing details about the policy and the entry that matched that policy.

It would be possible to provide a policy that causes the CCMS to react to certain messages with more drastic action, including, for example, interfering with the ongoing progress of the message (e.g., blocking the offending message, suspending further communication between the sender and receiver, etc.). However it is generally an object of the present invention to refrain from disruptions, disconnections and associated data processing bottlenecks. Therefore, in most installations, a reporting message is preferred over disconnecting or blocking a communication, or similarly heavy handed responses.

The content scanner waits a predefined time after completing processing of a given entry before scanning the next entry. When the content scanner is started by the search form in the user interface 205-1, the content scanner performs the same steps except instead of loading the policies, the content scanner uses the search criteria provided by the user. Also, instead of marking matched event entries the content scanner stores a reference to those entries in a temporary table which is then displayed to the user in the analyst 205-1 part of the GUI 205. This procedure enables the user to monitor for more tentative selection criteria that generally assist the network operations planners in determining discreetly how the network and its bandwidth are being exploited by operations in the regular course of business.

Data exports from the SMC database 203 to the Stored Data Server database 302 allow keeping the database 203 sized for optimal performance, i.e., small enough for rapid searches and report generation. The data export function can be a background process or can be started interactively by the user from the admin user interface 205-2 when desired. When started (routinely or upon starting by the admin user), a data export and cleanup service 204 updates the stored data server's database 302 using the PPAM SQL scripts, thus ensuring that the data structures at both databases are identical. Next, the data export & cleanup service collects the IDs of recent entries in tables in the SMC database 203. That way the service is able to ignore new entries that may be stored in the tables while the export service 204 is running. Next the service iterates through the tables and through the records in the tables, copying the records to the stored data server's database 302. Once the tables are cycled, the service deletes the exported records from the SMC database 203 using the IDs retrieved in the beginning. When the export is completed, the SMC notifies the indexing data server 400 that it can start the data indexing process.

The data export and cleanup service can also process and/or delete data from the SMC's database 203 so if there is no leftover stored data or to provide a clean initialization state. This is done the same way the export process operates with the exception that records are permanently deleted instead of copied and deleted.

The reporting service 201-1 generates reports per user defined criteria entered via the analyst interface 205-1. The user can select predefined report types in the GUI as well as define additional filtering criteria as time span, hosts, protocols and policies. The reporting service can be activated either instantaneously via the web GUI 205-1 or scheduled using the cron service 210. Once activated, it collects the needed information from the database 203 and generates the specified reports. The service has an internal delay to prevent the database 203 from overloading. Once a report is generated, it is sent to the designated users by the notification service 201-2.

The notification service 201-2 is used by SMC 200 components to send email notifications. The service in turn uses ether the SMC's built in email server 209 or an external email server specified in the web GUI 205-1.

The cron service 210 is used to schedule various SMC tasks such as reporting and database exports. It uses the cron daemon and the scheduling is controlled by the web GUI 205. The communication client 206 is used by the SMC to communicate with the other CCMS components' communication servers 102, 301 and 401. The client uses a TCP connection to send its command to the other components as well to receive data from them. All the communication is passed trough the encryption 503 module.

Referring to FIG. 8, the stored data server 300's main component is the stored data database 302. If the stored data server 300 is running on a separate hardware server it also requires a communication server 301. The SMC 200 can query the communication server 301 using the communication client 206 in order to retrieve information about the server 300 including processor, memory and disk space utilization. This information is retrieved by the communication server from the operation system 501. The stored server's database 302 is secured using encrypted file system 502.

The indexed data server 400 holds the index database 402 as well as the archive database 405. If the stored data server is running on a separate hardware server, it also requires a communication server 401 which allow the SMC 200 to send commands to the indexed data server as well as to receive data back about the server. The SMC 200 can query the communication server 401 using the communication client 206 in order to retrieve information about processor, memory and disk space utilization. This information is retrieved by the communication server from the operation system 501. The index database 402 is secured using encrypted file system 502. The indexed data server 400 also runs the indexing 403 and the archiving 404 services which are described in details in the next sections.

Once the SMC's data export service 204 completes a data export run its communication client 206 notifies the indexing server 400 using its communication server 401. This starts the indexing service 403 which indexes the data stored in stored data server's database 302. The indexing process iterates the records in the events log table. For each entry it retrieves protocol data as well encoding type. Using that information, the data is then converted to text, removing unneeded information. The same methods are used as in the content scanner 202. Once the data is in text format, the indexing process iterates each word in the text first checking that word against a list of predefined ignored words. If the word is not in the ignored words list it is added to a hash table using the word itself to generate the hash key. For each word, an ID of the events log entry is added into the hash table. When all the words are processed, the hash table is saved into the database 402 along with the corresponding IDs for each hash. The process is repeated for each entry in the events log table.

To save space and allow for a very long storage period, virtually only limited by the size of the partition holding the index database 402, data from the stored data database 302 can be archived on external tape media using the tape drive 406 and the archiving service 404. Once the data is archived, it is removed permanently from the stored data server's database 302. The index records for that data remain in the indexing data server's database 402 thus allowing users to do index searches using the web GUI 205-1. In addition, during the archive process all the records in the index data server that point to a data slice that will be archived are marked in the indexing database 402 so users can see that the data is no longer available in the CCMS. A unique archive name is also added to the data log in the index server.

The data is archived following the same algorithm as it is transferred from the SMC database 203 to the stored data server's database 302. A temporary archive database 405 is created with the same structure as the database 302. All the tables in the stored data database are iterated and copied, entry by entry, to the archive database 405. As each table is cycled, the size of the temporary database is monitored and not permitted to exceed the archive size defined by the user via the GUI 205-2. For each record being “moved” to the archive database the indexes in the indexed database 402 are updated to show that the data they are pointing is archived and is no longer available in the stored data server 302.

Once the specified data is transferred or the size of the archive database reaches a specified tape media size the archive process removes the entries that was archived from the stored data server. Next the archive database is disconnected and the data file itself is encrypted using the SMC's unique identifier as an encryption key. Once the file is encrypted it is streamed to the tape drive and if the streaming operation is completed successfully the file is deleted. The physical name under which the file was recorded to the tape drive is stored in the SMC's database 203.

Should a user initiated index search determines that certain data messages need to be retrieved from tape, the archive service 404 can restore a tape archive back to the archive database 405 and the data message details can be made available to the user. Only one tape archive can be restored at a time. The user restores the tape archive using the SMC interface 205. The archive is streamed back from the tape media to the file system. Next, the archive is decrypted using the SMC's unique identifier. The SMC detects the restored database automatically and provides the user with the option to switch the stored data view in the web GUI 205 to show the data from the archive database 405.

An encryption module 503 provides encryption for database transfers and communications between the different CCMS servers. The module is configured to listen on the 127.x.x.x network. All the database servers as well as the communication servers are configured to connect to 127.x.x.x as opposed to the real IP address of the machine on which they are running on. The encryption server in tern opens a connection or socket on the real IP address. If the encryption server is creating a connection to another CCMS server, it will first create a secure channel using asymmetrical encryption based on public/private keys. Once this channel is created, the servers will exchange a randomly selected key and recreate the channel using this key and symmetrical encryption.

After the symmetrical encryption channel is created the actual communication between the servers will be carried out through it.

The CCMS in general provides a communication monitoring apparatus for data communications over a network having a plurality of terminals coupled to at least one communications channel, at least certain of the terminals being operable for at least one of sending and receiving data messages on the communications channel. An exemplary network as described is a TCP/IP network with one or more LANs and/or WANS, typically coupled to one another and to the Internet, in a manner whereby the monitoring apparatus 001 can be coupled to at least a port mirror 602 or similar node at which packet communications are passed.

At least one processor 100 is associated with at least a subset of the communicating terminals 605 and servers coupled to the network. The subset can correspond to a LAN or group of LANs or to a subnet or other subset that is distinguishable by network addressing. A network probe 100 monitors data messages on the communications channel. The at least one processor 100 is configured to receive and to retain at least temporarily a copy of data messages, to resolve address and/or content information associated with the data messages, and to determine whether the messages meet predetermined selection criteria. Preferably, a supervisory admin or console operator is enabled by use of the processor or an associated processor 200 to manage the selection criteria and to react if necessary when a message meets the criteria.

At least certain of the data messages selected by the network probe are retained at least temporarily and preferably in a long term indexed database. At least one data server 300, 400 is coupled to manage the data storage.

A communications management process determines using the network probe that particular messages meet or do not meet the predetermined selection criteria and cause the messages to be treated in distinct ways. These ways include ignoring routine messages, passing up messages that meet certain criteria, re-assembling packet messages in order or without headers or otherwise free of message processing aspects. The messages can be analyzed and even blocked according to particular rules, although message blocking is generally not preferred. Data messages that meet certain criteria can be logged, stored, flagged, indexed for searching, and used to generate alarms and reports.

The network probe functions, the data server and the communication management processes are modular, being capable of embodiment in alternative ways and capable of embodiment in one monitoring appliance coupled as a terminal on the monitored network, or having processing functions distributed over plural processors or terminals.

The selection criteria used to discriminate among data messages can be tailored to the network or business interests of the establishment operating the network. The criteria generally include at least one of the appearance of predetermined data strings in the content, the appearance of predetermined strings in URLs and IP addresses, sending or receiving from predetermined domain levels and categories, use of certain protocols such as streaming protocols, protocols capable of encapsulating one or more other protocols, peer file sharing protocols, encryption and the like.

The invention comprises the programmed system as described, the methods that are practiced using the system for its programmed functions, and programming storage media that embodies software configured for practicing the claimed method and/or embodying the programmed apparatus.

The invention has been disclosed in connection with a number of examples and embodiments intended to illustrate the inventive subject mater. However the invention is not limited to the embodiments disclosed as examples, and is capable of other specific configurations. Accordingly, reference should be made to the appended claims rather than the disclosure of specific examples, to assess the scope of exclusive rights claimed.

What is claimed is:

1. A communication monitoring apparatus for data communications over a network having a plurality of terminals coupled to at least one communications channel, at least certain of the terminals being operable for at least one of sending and receiving data messages on the communications channel, the apparatus comprising:
at least one processor programmed to effect a network probe function with respect to the data messages on the communications channel, wherein said processor is configured to receive and to retain at least temporarily a copy of at least selected ones of the data messages, to resolve at least one of addressing and content information associated with said data messages, and to analyze the data messages so as to determine whether the messages meet predetermined selection criteria;
a data server coupled to the processor programmed to effect the network probe function, the data server being operable to store the content of the data messages for reference;
a communication management process for selectively handling the data messages, operable from at least one console terminal coupled to one of the communications channel and the analyzer, wherein the communication management process is operable according to a determination by the network probe function that particular messages meet or do not meet the predetermined selection criteria to treat said messages in distinct ways for at least one of: passing and blocking messages, logging and ignoring messages, storing copies of a subset of said messages, marking messages, generating alarms, and generating reports.

2. The apparatus of claim 1, wherein the network probe function, data server and communication management process are modular processes capable of distribution over a plurality of processors associated with the terminals.

3. The apparatus of claim 1, wherein the data messages comprise packet data transfers and the at least one processor is configured to assemble the content of the data messages from a plurality of associated packets.

4. The apparatus of claim 1, wherein the data server is configured to manage storage of an indexed database containing the content from at least a subset of all the data messages.

5. The apparatus of claim 4, wherein the communication management process is operable over the console terminal for at least one of presenting alarms and for generating reports associated with data messages that met the predetermined selection criteria.

6. The apparatus of claim 1, wherein the communication management process is operable over the console terminal for presenting an alarm and at least one report associated with temporarily buffered storage of data messages that met the predetermined selection criteria.

7. The apparatus of claim 1, wherein the communications channel couples the terminals in at least one local network.

8. The apparatus of claim 7, wherein the messages include TCP/IP data packets sent and received among the terminals and over at least one channel to a wide area network.

9. The apparatus of claim 8, wherein respective ones of the messages carry data packets in different data protocols, and wherein the processor programmed to effect the network probe function is arranged to distinguish a protocol of each processed data packet in conjunction with resolving the content.

10. The apparatus of claim 9, wherein the processor programmed to effect the network probe function is provided with modular plug-in protocol routines that each contain a protocol identification and programmed processes for extracting the content according to the protocol that is distinguished.

11. The apparatus of claim 10, wherein the predetermined selection criteria vary according to at least one of the protocol of each said processed data packet, authorization rights associated with the terminals, authorization rights associated with users of the terminals, and arbitrary criteria selected from the console terminal.

12. The apparatus of claim 1, wherein the at least one processor is programmed passively to collect at least selected portions of the content of the data messages and the data server is arranged to store the content in an indexed database for later access.

13. The apparatus of claim 1, wherein the at least one processor is programmed actively to generate an alarm upon analyzing data messages that meet a subset of the predetermined selection criteria associated with at least one of security, legality and operator policy.

14. The apparatus of claim 13, wherein the predetermined selection criteria includes at least one of appearance of predetermined data strings in the content, appearance of predetermined strings in URLs and IP addresses, sending or receiving from predetermined domain levels and categories, use of encryption protocols, use of protocols capable of encapsulating one or more other protocols, and operations characteristic of peer-to-peer sharing.

15. A method for managing network communications involving user terminals on a managed network wherein packet data messages are transferable in at least one direction between said user terminals and terminals within and outside of the managed network, comprising the steps of:
coupling a terminal to the managed network at a communication node through which at least a subset of the packet data messages are passed;
collecting and assembling associated ones of the packet data messages associated with one of terminals and users;
determining aspects of the packet data messages including at least one of: an associated communication protocol, data strings included as content of the packet data messages, data strings containing addressing information, characteristics associated with media formatting, characteristics associated with data sharing configurations, encryption and protocol encapsulation;
at least temporarily storing at least a representation of part of said aspects and comparing the aspects to selection criteria, and as a result of said comparing, generating at least one of a flag marking a message, an alarm, a report and a statistical data value;
providing a supervisory console operable for at least one of manipulating the selection criteria and reviewing the representation of the aspects.

16. The method of claim 15, wherein said collecting of the packet data messages comprises passively accumulating the packet data messages that are received and sent by and from the terminals and users.

17. The method of claim 15, further comprising maintaining an archive database of at least one of the packet data messages and the aspects determined therefrom.

18. The method of claim 17, further comprising accessing the archive database in connection with a determination that aspects of a temporarily stored message meet the selection criteria.
